(19) United States
(12) Patent Application Publication
(10) Pub. No.: US 2010/0322310 A1
(43) Pub. Date: Dec. 23, 2010

(54) Video Processing Method

(76) Inventors: Hui Deng, Hangzhou City (CN); CongXiu Wang, Hangzhou City (CN); Jiangen Cao, Hangzhou City (CN)

Correspondence Address: NORTH AMERICA INTELLECTUAL PROPERTY CORPORATION, P.O. BOX 506, MERRIFIELD, VA, 22116, US

(21) Appl. No.: 12/725,475

(22) Filed: Mar. 17, 2010

(30) Foreign Application Priority Data
Jun. 23, 2009 (CN) 200910150318.7

(51) Int. Cl. H04N 7/32

(52) U.S. Cl. 375/240.12; 375/E07.243

(57) ABSTRACT

A first video stream is analyzed for generating consecutive video segments. Each video segment indicates a specific scene in the video stream. A first intra frame is added at a start of each of the video segments, and second intra frames are inserted each fixed interval of video frames from the start of each of the video segments for spacing two consecutive second intra frames by the fixed interval of video frames in each of the video segments.

### BACKGROUND OF THE INVENTION

1. Field of the Invention

The present invention relates to a video processing method, and more particularly, to a video encoding and editing method applied to embedded electronic products.

2. Description of the Prior Art

Portable electronic products capable of recording videos are increasing, and video streams recorded by the portable electronic products must meet various requirements. However, the recorded video streams also include unnecessary content, and the unnecessary content becomes a burden in storage and transmission by the portable electronic product. When using a conventional embedded electronic product to record video streams, functions for editing the recorded video streams are not provided, and therefore a user of the embedded electronic product cannot browse and edit the recorded video streams directly until the user decodes the recorded video streams. Further, since the user may only browse and edit the recorded video streams after the recorded video streams are completely decoded, the embedded electronic product must allow for additional temporary storage for storing the decoded video streams, not to mention that a central processing unit of the embedded electronic product must also include a significantly increased number of video processing functions.

A recorded video stream of a conventional embedded electronic product includes a plurality of consecutively-distributed video frames, which serve as a unit in encoding or decoding the video stream. Concretely speaking, the plurality of video frames includes non-predictive frames and predictive frames. A predictive frame has to be encoded by referencing its neighboring video frames, whereas a non-predictive video frame can be encoded by merely referencing itself. Sometimes, when recording a video stream on a conventional embedded electronic product, a first scene of the video stream transitions sharply to a second scene. However, if the user wants to edit the recorded video stream according to transitions between scenes, the user has no convenient way of locating the transitions. Thus, the user may have to look through each frame of the video stream to find frames corresponding to the transition from the first scene to the second scene. Further, before decoding the recorded video stream, the user may be completely unable to determine precisely at what moment the transition occurred between the scenes by browsing the recorded video stream, thus being unable to edit the recorded video stream by unknown lengths of the scenes in the recorded video stream.

### SUMMARY OF THE INVENTION

According to an embodiment of the present invention, in a video processing method a first video stream is analyzed for generating a plurality of consecutive video segments. Each of the plurality of consecutive video segments indicates a specific scene in the video stream. A first intra frame is added at a start of each of the plurality of video segments, and a second intra frame is inserted each fixed interval of video frames from the start of each of the plurality of video segments for spacing two consecutive second intra frames by the fixed interval of video frames in each of the plurality of video segments.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating insertion of intra frames between video segments representing different scenes in a video stream recorded by an embedded electronic product according to an embodiment of the present invention.

FIG. 2 is a diagram illustrating insertion of intra frames at fixed intervals in a method according to an embodiment of the present invention.

FIG. 3 is a flowchart of a video processing method according to an embodiment of the present invention.

### DETAILED DESCRIPTION

To overcome the problems faced by embedded electronic products of the prior art that limit video stream recording and make it difficult for the user to edit the video stream conveniently, the embodiments of the present invention provide a video processing method that allows the user to avoid the complicated decoding and editing process, and edit the video streams he/she records at will.

In the embodiments described below, a recorded video stream is first split into different video segments according to different scenes. It is assumed in the following that a recorded video stream comprises the following scenes: riding a bicycle, viewing the ocean, and riding a train. The scenes provide an example for illustrating definition of different scenes of the video stream. In the bicycle riding scene, a lens is focused on the bicycle being ridden, such that pixel groups in images of the entire scene do not change noticeably. Likewise, in the ocean viewing scene and the train ride scene, corresponding images throughout the scenes do not change noticeably because the lens is focused on either the ocean or the train. In the embodiments of the present invention, when the user is using the embedded electronic product to record the video stream, specific tags may be added through simple commands when scene changes occur. Or, the embedded electronic product may automatically detect scene changes, and add specific tags when more intense changes occur between images.

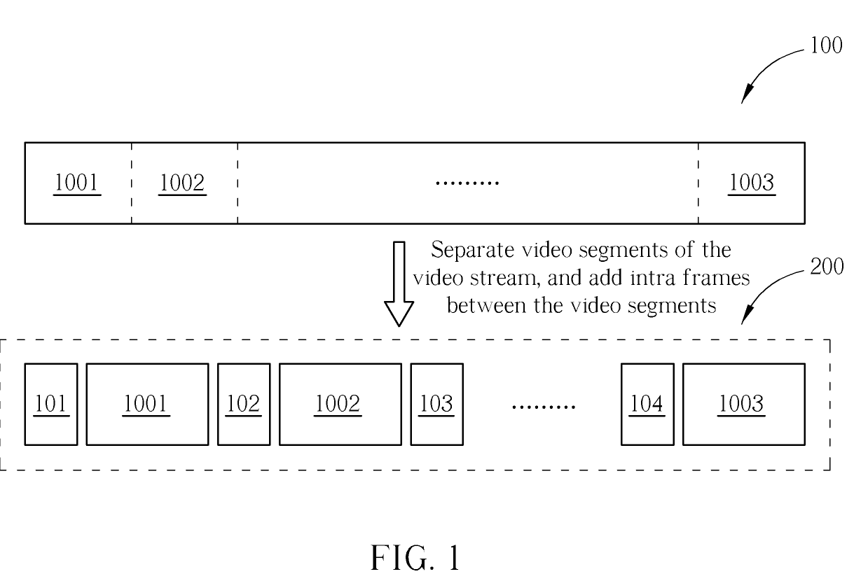

Briefly, a video stream may be considered a set of video segments corresponding to multiple different scenes. However, conventional embedded electronic products are not typically equipped with video processing functions capable of segmenting the video stream into the set of video segments based on the different scenes. In the embodiments of the present invention, the video segments are physically separated in the recorded video stream. For example, when a recorded video stream comprises two video segments corresponding to two different automobiles recorded by the embedded electronic product, using the method of the embodiments of the present invention, the two video segments may be split by adding an intra frame between the two video segments, thereby physically segmenting and defining the two video segments in the video stream. The intra frame may be a non-predictive frame, such that encoding or decoding of the intra frame may be performed without referencing other frames at neighboring times. Please refer to FIG. 1, which is a diagram illustrating insertion of intra frames between video segments representing different scenes in a video stream recorded by an embedded electronic product according to an embodiment of the present invention. As shown in FIG. 1, a video stream 100 may be recorded by an embedded electronic product. Thus, the video stream 100 may comprise a plurality of video segments 1001, 1002, . . . , 1003 that are not physically separated. A video stream 200 may be recorded according to the method of the embodiments of the present invention, and may comprise a plurality of video segments 1001, 1002, . . . , 1003 equivalent to those of the video stream 100 that are split apart by adding a plurality of intra frames 101, 102, 103, . . . , 104. In this way, a user of the embedded electronic product may utilize the added intra frames 101, 102, 103, . . . , 104 as a convenient reference for browsing the individual video segments comprised by the video stream 200, and may immediately ascertain length, order, and content information of each video segment.

As described previously, a conventional video stream comprises predictive frames and non-predictive frames, and intra frames are a type of non-predictive frame. In the method of the embodiments of the present invention, video frames that the user may freely browse while editing the video stream may be set as intra frames, so that the user may quickly and accurately locate the beginning of each video segment when performing editing on the plurality of video segments split out of the video stream. Other non-predictive frames comprised by the video stream may be made unavailable for browsing during editing. As can be seen from the description of FIG. 1, the beginning frame of each video segment must be an intra frame, to provide a high degree of certainty that the user can quickly locate the beginning of the video segment he/she wishes to edit, and begin browsing the video segment.

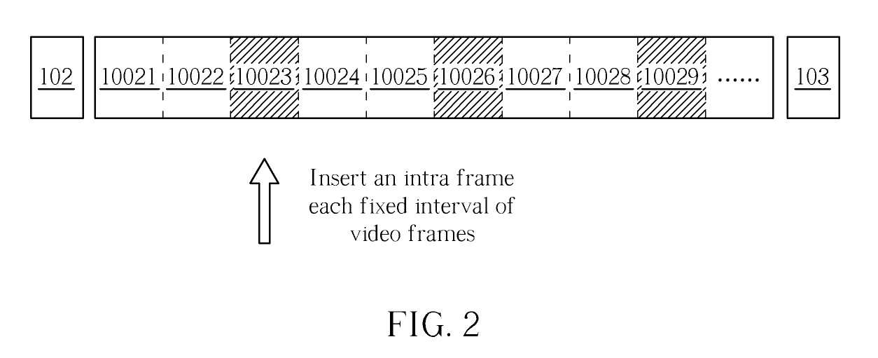

In addition, in a conventional video stream, non-predictive video frames are captured every fixed number of frames to ensure video stream playback quality. In the method of the embodiments of the present invention, an intra frame is inserted every fixed number of frames for each video segment to ensure playback quality of each video segment. Please refer to FIG. 2, which is a diagram illustrating insertion of intra frames at fixed intervals in a method according to an embodiment of the present invention. FIG. 2 takes the video segment 1002 shown in FIG. 1 as an example for illustration. In FIG. 2, the video segment 1002 may comprise at least a plurality of video frames 10021, 10022, . . . , 10029, etc. The video frames 10023, 10026, 10029 may be intra frames, and the video frames 10021, 10022, 10024, 10025, 10027, 10028 may be predictive video frames. In the video segment 1002, the intra frames 10023, 10026, 10029 may have a fixed interval of every two predictive video frames, and may be inserted into the video segment 1002 during recording of the video stream 200.

When no intra frames are inserted at fixed intervals, minor visual errors accumulated during video segment encoding may be readily apparent. Utilizing intra frames inserted at fixed intervals may eliminate the accumulation of errors during encoding of the video segment. In addition, due to encoding characteristics of predictive video frames and non-predictive video frames, predictive video frames have at least some degree of dependence upon other video frames located at different times. Errors then accumulate steadily with this dependence. Non-predictive video frames are encoded without reference to video frames located at different times. Thus, non-predictive video frames do not accumulate errors generated or accumulated by video frames at other times. Although encoding of non-predictive video frames requires heavier, more complex calculations than predictive video frames, compared to predictive video frames, non-predictive video frames provide higher quality and accuracy in encoding. Thus, the embodiments of the present invention may ensure browsing quality of each video segment by inserting intra frames at fixed intervals in each video segment of the video stream.

Please note that insertion of intra frames at fixed intervals in the video segment as shown in FIG. 2 is only an embodiment of the present invention. Different fixed interval lengths may be utilized in other embodiments of the present invention without leaving the teachings of the present invention.

Utilizing the method of inserting intra frames to separate video segments shown in FIG. 1, the embedded electronic product may reserve a large, convenient video segment editing space for the user. For example, according to the method described above, beginning intra frames comprised in each video segment may be found quickly by searching the intra frames, and each video segment may be represented by its corresponding beginning image to provide an index to the user for locating each video segment, so that the user may rapidly choose the video segment he/she wishes to browse or edit. This method of providing an editing space to the user is much faster, and reduces encoding calculations over the conventional embedded electronic product, which must encode the entire video stream before the user may start editing or browsing. Although the method provides the user with a space for performing editing on individual video segments, the method may also provide another space for the user to perform editing on the overall video stream directly. By inserting an intra frame at the beginning of each video segment as described above, embedded electronic products utilizing the method may save a large number of calculations.

According to the method described above, when encoding each video segment comprised by the video stream, it is common for some video frames to be removed from each video segment for various reasons, including video output considerations of the embedded electronic product, e.g. color composition of the plurality of video frames comprised by each video segment, amount of image variation, or amount of difference from neighboring video frames. When determining which video frames need to be deleted during encoding of the video segment, a priority is determined for each video frame of each video segment. The priority is determined based on the color composition, image variation, and difference from neighboring video frames described above. In addition, conventional encoding applies a compression ratio when performing encoding of the video stream. In the method described above, the compression ratio may also be used to determine which video frames are deleted in each video segment. The method also gives the user freedom to determine which video frames of each video segment are deleted. The user need only activate a simple command to decide which video frames he/she wishes to delete after using the method shown in FIG. 1 and FIG. 2 to find the video segment he/she desires to edit. After finishing deletion of video frames or editing of each video segment, encoding may be performed again immediately to update each video segment of the video stream, thereby completing video stream encoding.

Please note that other than encoding the video stream by performing encoding after completion of editing and deletion of video frames as described above, video segment editing and encoding may also be completed simultaneously, and encoding may be performed on the video stream thereafter. More specifically, after completing editing and encoding of a single video segment, an encoding command may be received from the user or the embedded electronic product, and a corresponding updated video segment may be generated immediately. In this way, the user's what-you-see-is-what-you-get (WYSIWYG) requirement may be satisfied when editing the video segment of the video stream.

The method may be used with MPEG (Moving Picture Experts Group) video encoding codecs, ITU (Telecommunication Standardization Sector) video encoding codecs, or other types of proprietary video encoding codecs. Thus, any of the abovementioned video encoding codecs may be applied in the method described above without leaving the spirit of the present invention.

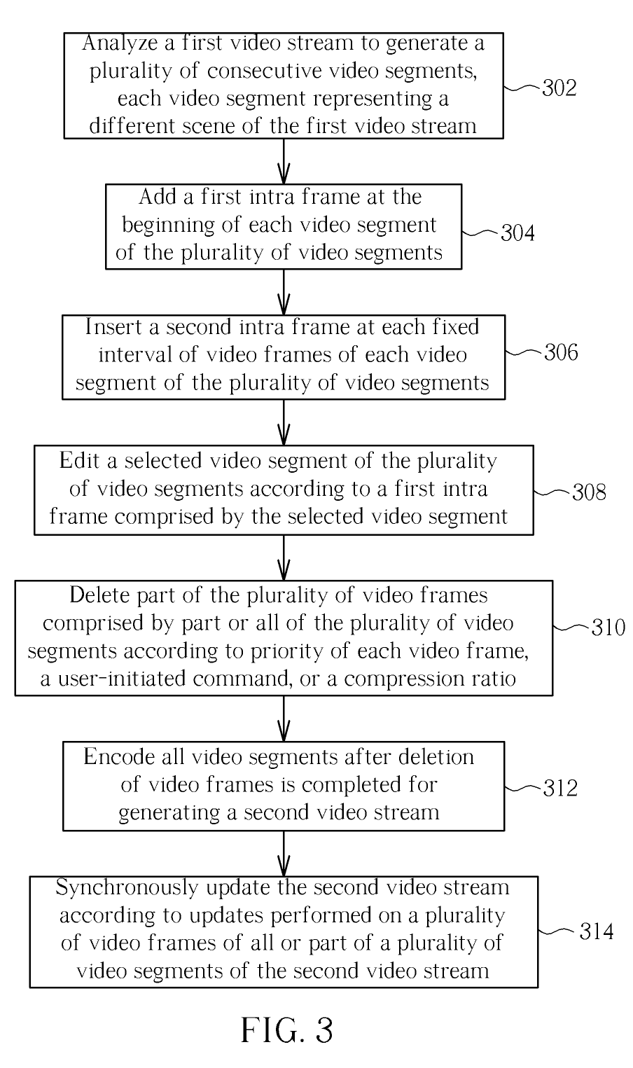

Please refer to FIG. 3, which is a flowchart of a video processing method according to an embodiment of the present invention. The video processing method may be performed according to the description given above for FIG. 1, FIG. 2, and any other description of the embodiments given herein. As shown in FIG. 3, the video processing method comprises:

Step 302: Analyze a first video stream to generate a plurality of consecutive video segments, each video segment representing a different scene of the first video stream;

Step 304: Add a first intra frame at the beginning of each video segment of the plurality of video segments;

Step 306: Insert a second intra frame at each fixed interval of video frames of each video segment of the plurality of video segments;

Step 308: Edit a selected video segment of the plurality of video segments according to a first intra frame comprised by the selected video segment;

Step 310: Delete part of the plurality of video frames comprised by part or all of the plurality of video segments according to priority of each video frame, a user-initiated command, or a compression ratio;

Step 312: Encode all video segments after deletion of video frames is completed for generating a second video stream; and

Step 314: Synchronously update the second video stream according to updates performed on a plurality of video frames of all or part of a plurality of video segments of the second video stream.

The steps shown in FIG. 3 only represent a preferred embodiment of the present invention, and are not intended to limit the scope of the present invention. Different combinations and arrangements of the steps of the method shown in FIG. 3 to form different embodiments should also be considered part of the present invention.

The video processing method described above inserts intra frames at the beginnings of video segments representing different scenes during video stream recording as an aid for recognizing each video segment, allowing for rapid search of each video segment in the video stream recorded on the embedded electronic product. Thus, when the embedded electronic product or the user thereof needs to find at least one video segment for editing, the embedded electronic product need not encode the entire video stream first, but instead may use the intra frame inserted at the beginning of each video segment to recognize the desired video segment, then begin editing and encoding the desired video segment directly. Because only the desired video segment is edited and encoded, and not the entire video stream, processing load of the embedded electronic product is reduced greatly. Further, for video segments defined by the intra frames, the user may quickly determine length, order, and content of all video segments of the video stream, and may perform updates on specific video segments, such as deletion of video frames thereof. Edited video segments may be encoded immediately in the video stream after editing is completed, and may be encoded without needing to wait for the entire video stream to be encoded first. MPEG, ITU, and other proprietary video encoding codecs are all applicable in the method of the embodiments of the present invention, and embedded electronics products that may utilize the method include mobile phones, digital cameras, or any other portable multimedia recording and/or playback device.

Those skilled in the art will readily observe that numerous modifications and alterations of the device and method may be made while retaining the teachings of the invention.

What is claimed is:

1. A video processing method comprising:
analyzing a first video stream for generating a plurality of consecutive video segments, each of the plurality of consecutive video segments indicating a specific scene in the video stream;
adding a first intra frame at a start of each of the plurality of video segments; and
inserting a second intra frame each fixed interval of video frames from the start of each of the plurality of video segments for spacing two consecutive second intra frames by the fixed interval of video frames in each of the plurality of video segments.

2. The method of claim 1 further comprising:
editing the first video stream according to the first intra frame of each of the plurality of video segments.

3. The method of claim 2 wherein editing the first video stream according to the first intra frame of each of the plurality of video segments comprises:
displaying each of the plurality of video segments according to the first intra frame of each of the plurality of video segments.

4. The method of claim 1 further comprising:
editing a chosen video segment from the plurality of video segments according to a first intra frame of the chosen video segment.

5. The method of claim 1 wherein each of the plurality of video segments comprises a plurality of consecutive video frames.

6. The method of claim 5 further comprising:
determining a priority of each of the plurality of video frames of each of the plurality of video segments according to color decomposition, frame variation, or a difference from a neighboring video frame, of each of the plurality of video frames;
deleting part of a plurality of video frames of part or all of the plurality of video segments; and
encoding remaining video segments after the deletion is completed for generating a second video stream.

7. The method of claim 5 further comprising:
deleting part of a plurality of video frames of part of the plurality of video segments according to a command issued from a user; and
encoding remaining video segments after the deletion is completed for generating a second video stream.

8. The method of claim 5 further comprising:
deleting part of a plurality of video frames of each of the plurality of video segments according to a compression ratio; and
encoding remaining video segments after the deletion is completed for generating a second video stream.

9. The method of claim 5 further comprising:
deleting part of a plurality of video frames of part or all of the plurality of video segments and encoding remaining video segments after the deletion is completed for generating a second video stream; and
synchronously updating the second video stream according to updates of a plurality of video frames of part or all of a plurality of video segments of the second video stream.
